(19) United States
(12) Patent Application Publication
(10) Pub. No.: US 2002/0118646 A1
(43) Pub. Date: Aug. 29, 2002

(54) Device and process for flow control in a switched network

(76) Inventor: Jean-Francois Saint Etienne, Cugnaux (FR)

Correspondence Address: Robert E. Krebs, BURNS, DOANE, SWECKER & MATHIS, L.L.P., P.O. Box 1404, Alexandria, VA, 22313-1404, US

(21) Appl. No.: 09/995,820

(22) Filed: Nov. 29, 2001

(30) Foreign Application Priority Data
Dec. 21, 2000 (FR) 00 16766

(51) Int. Cl. H04J 1/16

(52) U.S. Cl. 370/235; 370/252

(57) ABSTRACT

The present invention relates to a flow control device in a switched network comprising at least one transmitter device and at least one receiver device linked together through at least one switch (20), in which a virtual link, which is a logical link using at least one physical link, allows information to be sent from a transmitter to at least one receiver, in which each switch (20) contains an allocation table (T), defined statically, which associates a bandwidth with each of the virtual links so as to guarantee a maximum transmission period of an element of information in each virtual link and an allocation such that for every physical link the sum of the bandwidths allocated to the various virtual links using this physical link is less than the bandwidth of this physical link.

The present invention also relates to a flow control process in a switched network.

### TECHNICAL FIELD

The present invention relates to a device and process for flow control in a switched network, notably in the field of communication between onboard equipment, such as for example computers, in the avionics field.

### STATE OF PRIOR TECHNOLOGY

Communication networks of known art used in the avionics field often have an architecture similar to that represented in FIG. 1, corresponding to norm ARINC 429, in which n devices C₁, C₂, . . . Cₙ, for example computers, exchange information. Each transmitter has a physical link to each of the receivers. The information sent by one transmitter may occupy the entire bandwidth of the physical links concerned. Each of the devices C₁, C₂, . . . Cₙ outputs a transmission line E₁, E₂, . . . Eₙ linked to all the other devices which are considered as receivers in relation to this transmission line. This architecture has the advantage that it guarantees transmission of information from one transmitter to one or more receivers, without risk of conflict with the information sent by the other transmitters, since the latter use different physical links. The period of communication from a transmitter to a receiver is thus defined deterministically. However, when the number of interconnected devices is increased, the number of lines of communication very rapidly becomes very large. An architecture of this kind then has many disadvantages in terms of weight, quantity of connections (hence potential risks of breakdown), complexity, wiring time, maintenance, etc.

There are also other methods of communication which are based on bus-type architectures, as illustrated in FIG. 2, corresponding notably to norms ARINC 629 and MIL 1553. Multiplexed information then circulates in “half-duplex” mode between the various devices C₁, C₂, . . . Cₙ on a bus 10. This type of architecture is advantageous owing to the simplicity of the corresponding physical wiring. On the other hand, it requires that risks of collisions between the information from the various physical transmitters are managed, since the latter share the same physical link. In addition, the transmission rate is reduced compared to a point-to-point link since the bandwidth of each physical link is shared between different transmitters.

It is also known to use a star-shaped architecture around a central interface 20 implementing network switching functions, as illustrated in FIG. 3. n devices C₁, C2, . . . Cₙ are now linked to a switch 20 by means of links L₁, L₂, . . . Lₙ. The number of physical links (wire, etc.) is thus reduced.

More generally, the latter architecture may be extended to a network containing several switches 20 linked in cascade fashion, as illustrated in FIG. 4. It may be used in IT networks of the “Ethernet” type for communication between terminals. A network of this kind has the advantage that it requires only a relatively small number of links when the number of interconnected terminals grows large. However, a terminal Cᵢ (i=1,. . . , n) has only a single physical link, coming from the corresponding switch 20, for receiving information from all the other terminals and directed at this terminal Cᵢ. There is thus a risk of conflict if several terminals attempt to send simultaneously a large quantity of information to Cᵢ. This problem is resolved by using the notion of a virtual link: a virtual link is in effect a logical link allowing information to be sent from a transmitter to at least one receiver, with each virtual link using at least one physical link.

As illustrated in FIG. 5, each virtual link is single-direction from a transmitter to one or more receivers. The information is sent in the form of packages of data comprising a header representing the virtual link number. In an “Ethernet” network switch 20 manages the virtual links and transmission rates dynamically in order to adapt optimally to the instantaneous network traffic. The bandwidths of the various virtual links are allocated such that at any time the sum of the bandwidths of all the virtual links using a given physical link is less than the theoretical bandwidth of the said physical link, a bandwidth being a transmission capacity expressed as a number of items of information over a given unit of time, for example bit/s. Conversely, this dynamic allocation of bandwidths of the various virtual links does not enable it to be guaranteed that an item of information will be transmitted between two terminals in a given time. This is a major disadvantage for applications requiring imposed frequencies of refreshment of exchanged data.

The purpose of the invention is to overcome these disadvantages by providing a device and process for controlling flows in a switched network.

### ACCOUNT OF THE INVENTION

The invention relates to a device for controlling flows in a switched network comprising at least one transmitter device and at least one receiver device linked together across at least one switch, in which a virtual link, which is a logical link using at least one physical link, enables information to be sent from a transmitter to at least one receiver, characterised in that each switch contains an allocation table (T), defined statically, which associates a bandwidth with each of the virtual links so as to guarantee a maximum period for transmission of an item of information on each virtual link and an allocation such that for every physical link the sum of the bandwidths allocated to the various virtual links using this physical link is less than the bandwidth of this physical link.

Ideally the allocation table is such that a bandwidth may be allocated to a set of flows.

This device thus enables a maximum transmission period of an item of information on each virtual link to be guaranteed. To guarantee that there will never be any congestion of the communication network, this allocation is such that for every physical link, the sum of the bandwidths allocated to the various virtual links using this physical link is less than the bandwidth of this physical link, this bandwidth being dependent on the characteristics of the physical support.

The invention also relates to a flow control process in a switched network, comprising at least one transmitter device and at least one receiver device linked together across at least one switch, in which a virtual link, which is a logical link using at least one physical link, enables information to be sent from a transmitter to at least one receiver, characterised in that, in the switch, use is made of an allocation table (T), defined statically, which associates a bandwidth with each of the virtual links so as to guarantee a maximum transmission time of an item of information in each virtual link and an allocation such that for every physical link the sum of the bandwidths allocated to the various virtual links using this physical link is less than the bandwidth of this physical link.

Ideally the allocation table is such that a bandwidth may be allocated to a set of flows.

### BRIEF DESCRIPTION OF THE DRAWINGS

FIG. 1 illustrates a communication network of known art.

FIG. 2 illustrates a bus-type architecture of known art.

FIGS. 3 to 5 illustrates star-shape architectures of known art.

FIG. 6 illustrates the device of the invention.

FIG. 7 illustrates an example of embodiment implementing the process of the invention.

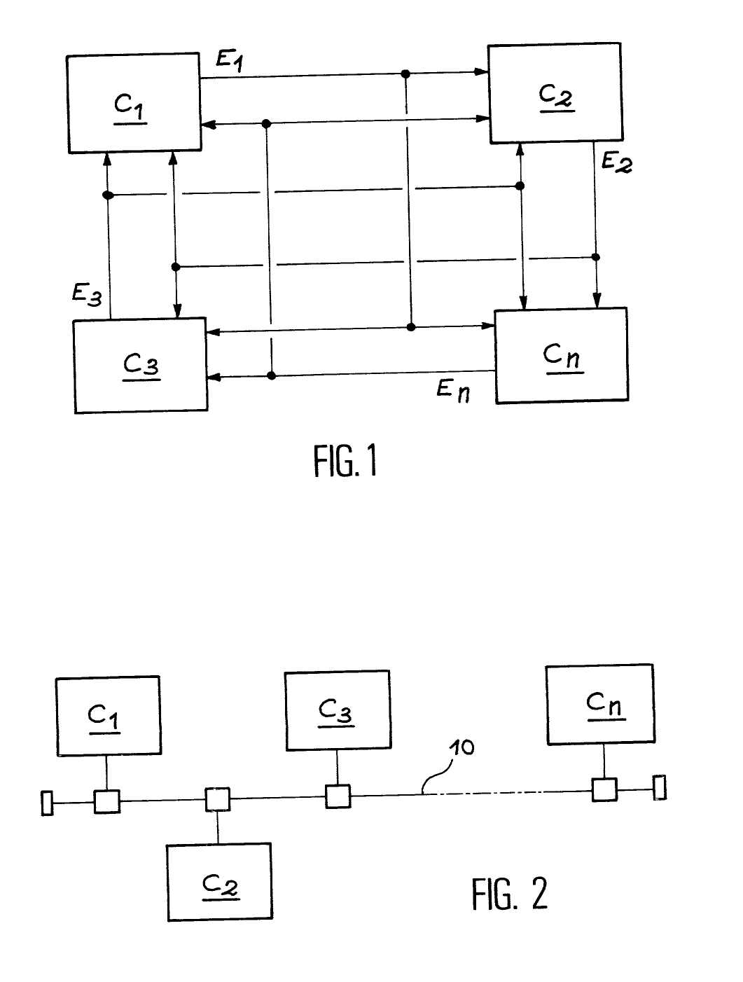

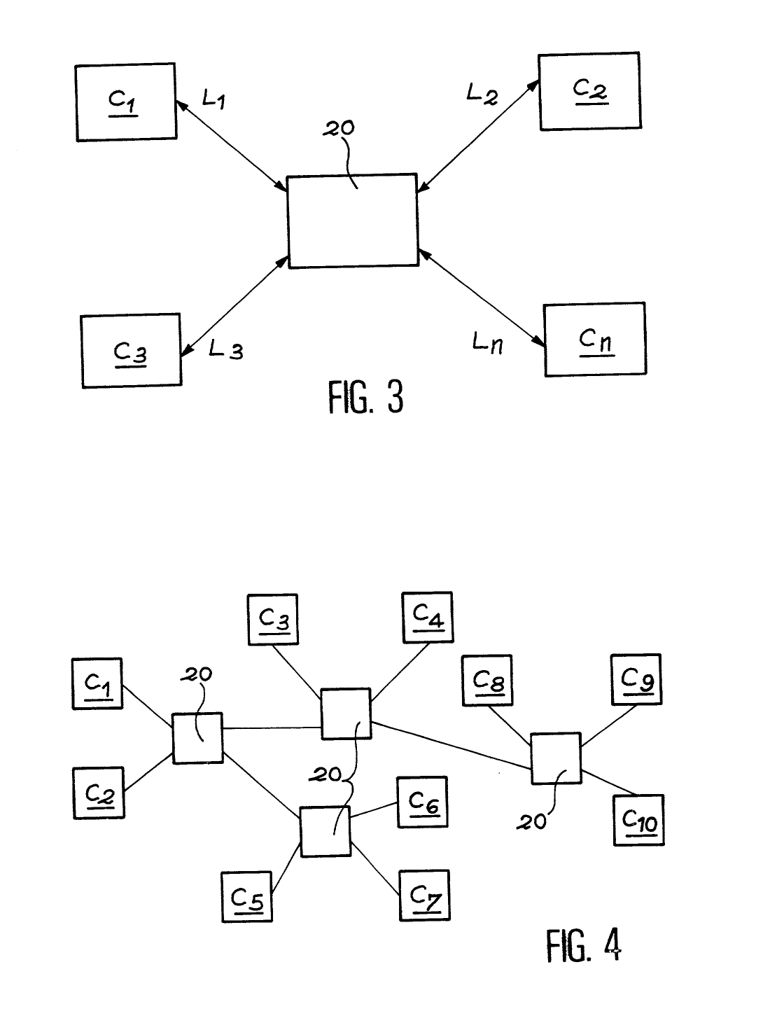

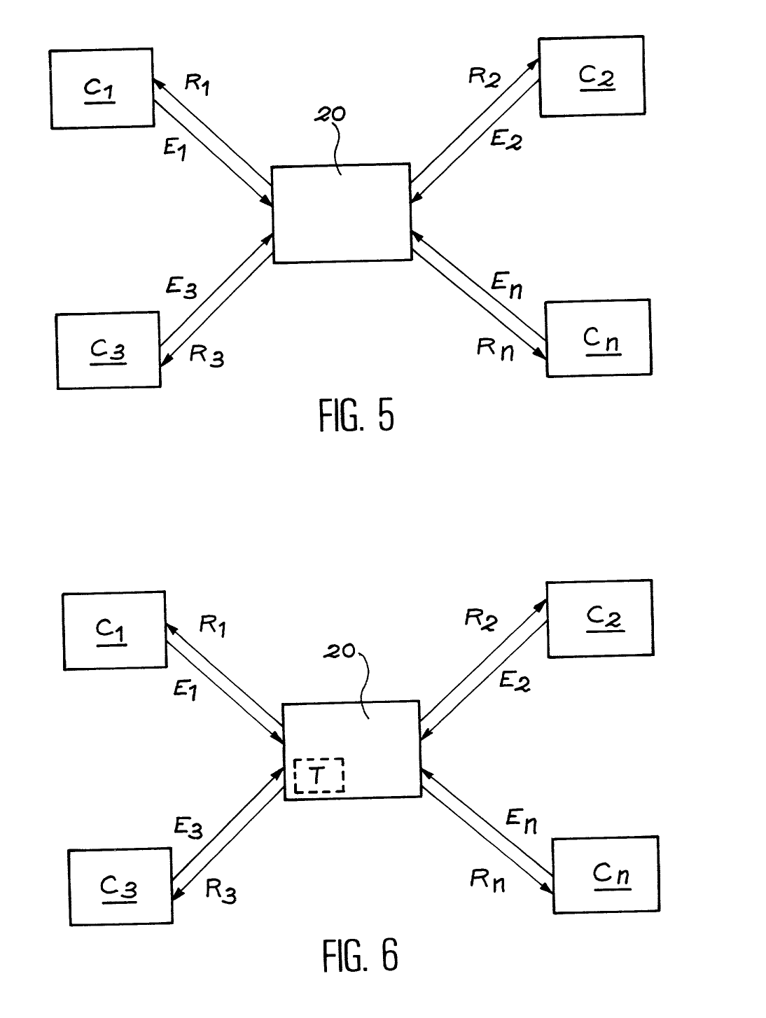

### DETAILED ACCOUNT OF EMBODIMENTS

The device of the invention uses a physical layer of the “Ethernet” type, as illustrated in FIG. 6. It implements specific switches 20 in which are defined, statically, an allocation table T the function of which is to associate a bandwidth with each of the virtual links.

Such a table T has the following form:

Physical ports

| Virtual link | Transmitters | Receivers | Bandwidth |
|---|---|---|---|
| . | | | |
| 14 | 1 | 3 | B₁₄ |
| 15 | 1 | 2 | B₁₅ |
| | | n | |
| 16 | 3 | 2 | B₁₆ |
| . | | | |

This static allocation of the bandwidths to the various virtual links allows a maximum period of transmission of an item of information from a transmitter device to one or more receiver devices to be guaranteed. Table T, defined above, thus has major advantages in terms of operational security.

In another embodiment, a bandwidth is allocated to a set of virtual links. When several virtual links, using at least one common physical link, are never all active simultaneously, it is possible to group these virtual links together. In the switch's table this group E of virtual links may then be allocated a smaller bandwidth than the sum of the bandwidths which would have been allocated to the various virtual links considered separately, without harming the performance of the device in respect of the maximum period of transmission of an item of information.

Since group E of virtual links requires a smaller bandwidth in the physical link, it is possible to pass more virtual links over this physical link. Or, if this is not necessary, it is possible to increase the bandwidth of this group of virtual links using the same physical link), enabling the maximum period of transmission of this information to be reduced.

Bearing in mind that the bandwidth required f or a sub-set of virtual links may be less than the sum of the individual bandwidths of each of these links considered independently from one another. This embodiment consists in defining the switch's table such that it is possible to allocate a bandwidth to a group E of virtual links.

Physical ports

| Virtual link | Transmitters | Receivers | Bandwidth |
|---|---|---|---|
| . | | | |
| 0 | 0 | 1 | B₀ |
| | | 2 | |
| | | 3 | |
| | | . | |
| | | n | |
| 1 } | 1 | | B_{G} |
| 2 } | 2 | | |
| 3 } E | 3 | 0 | |
| . } | . | | |
| n } | n | | |
| . | | | |

More generally, the virtual links sharing a given bandwidth may arrive at one or more switching ports.

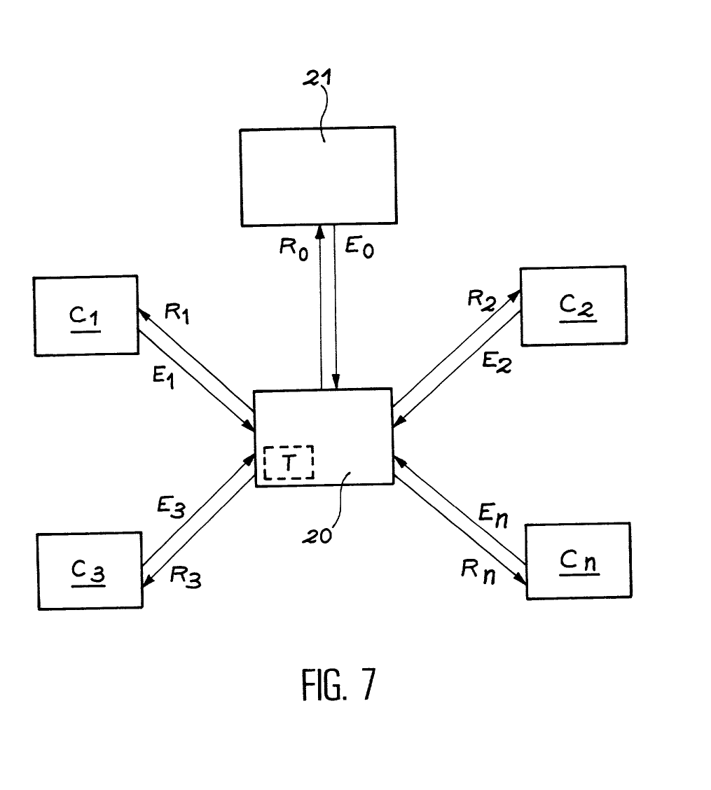

The following case may be cited as an example: during aircraft stopovers in airports, it is sometimes necessary to download updates of equipment, or to upload information, from a station 21, which is itself linked to the network as illustrated in FIG. 7. An operation of this kind requires a virtual link VL₀ of the download station 21 to each of the devices C₁, C₂, . . . , Cₙ (transmission of information to the devices), and n virtual links VL₁, . . . , VLₙ from the various devices to download station 21 (transmission of acknowledgement messages concerning the download). In practice the download is usually undertaken towards a single device at once. Consequently only one of the n virtual links VL₁. . . VLₙ is used at a given time. However, since allocation table T is static, a bandwidth must be allocated to each of these n links. Since allocation table T is identical during the flight phases and the stopover phases, the bandwidth usable for downloading is relatively small (since it is above all necessary to guarantee good communication between the various devices during flight), although sufficient to ensure a satisfactory data transmission rate from download station 21 to the devices. However, in the opposite direction (from the devices to the download station), the n virtual links VL₁, . . . , VLₙ must share a bandwidth of similar size to the previous one. The individual bandwidth of each of them is thus very small, the effect of which may be to slow down the download.

The device of the invention may be extended to any kind of network linking together devices which must exchange information with a guaranteed transmission rate. The notion of information flow may thus be considered, a flow being the equivalent of a virtual link in the specific case of the network previously studied. A flow corresponds to the transmission of information from a single transmitter to one or more receivers. Each flow is associated with a budget defined as being the maximum transmission capacity allocated to this flow. It corresponds to the bandwidth as defined above. In a traditional network a flow is associated with a single budget. In order to guarantee operational security, this association is undertaken statically in onboard networks such as those used, for example, in the avionics field. In order to achieve this static budget-flow allocation in an informed manner, the device of the invention allows a given budget to be allocated to several flows, which considered individually would require budgets the sum of which would exceed the total available budget.

1. A device for controlling flows in a switched network comprising at least one transmitter device and one receiver device linked together through at least one switch (20), in which a virtual link, which is a logical link using at least one physical link, enables information to be sent from a transmitter to at least one receiver, characterised in that each switch (20) contains an allocation table (T), defined statically, which associates a bandwidth with each of the virtual links so as to guarantee a maximum transmission time of an item of information on each virtual link and an allocation such that for every physical link the sum of the bandwidths allocated to the various virtual links using this physical link is less than the bandwidth of this physical link.

2. A device in claim 1, in which the allocation table (T) is such that a bandwidth may be allocated to a set of flows.

3. A process for controlling flows in a switched network, comprising at least one transmitter device and at least one receiver device linked together through at least one switch (20), in which a virtual link, which is a logical link using at least one physical link, allows information to be sent from a transmitter to at least one receiver, characterised in that, in the switch, an allocation table (T), defined statically, is used, which associates a bandwidth with each of the virtual links so as to guarantee a maximum transmission time of an item of information in relation to each virtual link and an allocation such that for every physical link the sum of the bandwidths allocated to the various virtual links using this physical link is less than the bandwidth of this physical link.

4. A process in claim 3, in which the allocation table (T) is such that a bandwidth may be allocated to a set of flows.
